(19) United States
(12) Patent Application Publication
(10) Pub. No.: US 2013/0061531 A1
(43) Pub. Date: Mar. 14, 2013

(54) Edge Guard for Door with Interior Sealant

(71) Applicant: Loren S. Adell, Collin County, TX (US)

(72) Inventor: Loren S. Adell, Collin County, TX (US)

(21) Appl. No.: 13/550,301

(22) Filed: Jul. 16, 2012

Related U.S. Application Data
(63) Continuation-in-part of application No. 12/387,350, filed on May 1, 2009, now abandoned.

(51) Int. Cl. E06B 7/232

(52) U.S. Cl. 49/490.1

(57) ABSTRACT

A door edge guard for a trailing edge of a car door having a seam covered by sealant on the interior of the door, includes a metal body having an internal portion facing the trailing edge of the door and an exterior portion facing away from the trailing edge, a curved base adapted to fit over the trailing edge, and an exterior leg extending from the base to fit against the exterior of the door. An interior leg fits against that part of the interior of the door extending from the base to near the sealant. The end of the leg of the metal body on the exterior of the door is folded to form a bead, but the interior leg is straight. The interior leg is also shorter than the exterior leg, the length of the interior leg typically being the length of the exterior leg to the folded end of the bead.

### CROSS-REFERENCE TO RELATED APPLICATIONS

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates in general to door edge guards mounted on the trailing edges of automobile doors. In particular, the invention relates to insulated metal door edge guards.

2. Description of Related Art

Door edge guards are mounted on the trailing edges of automobile doors to protect the edges of the doors and to protect objects that are struck by the door edge. For example, in a crowded parking lot the door edge may strike the side of an adjacent automobile. Without door edge guards, the door edges may be chipped and subsequently rust.

Metal door edge guards are generally made of stainless steel or aluminum. If the metal of the guard is different from the metal of the door, usually carbon steel, then the two metals must be insulated to prevent electrochemical action between the two metal from causing galvanic corrosion. Insulating materials are generally plastics, such as polyvinylchloride (PVC).

Automobile doors frequently form a seam on the inside of the door near the edge. Sealant is normally placed over the seam. In the past, the sealant was trimmed if a door edge guard was to be installed, especially since the door edge guards are installed by dealers rather than manufacturers.

In some cases, the door edge guard wraps around the edge of the door and is held in place by the friction between the door edge guard and the door edge. In other cases, a strip of double sided tape may be used to hold the guard in place.

### BRIEF SUMMARY OF THE INVENTION

A door edge guard according to the present invention for protecting the trailing edge of a door having a seam covered by sealant on the interior of the door includes a metal body having an internal portion facing the trailing edge and an exterior portion, a curved base adapted to fit over the trailing edge, an exterior leg extending from the base to fit against the exterior of the door, an interior leg to fit against that part of the interior of the door extending from the base to near the sealant, and an insulating cover coextruded or laminated onto the metal body to prevent contact between the metal body and metal in the door. The end of the leg of the metal body on the exterior of the door is folded to form a bead. The interior leg is straight, which is to say, it is not folded to form a bead. The interior leg is also shorter than the exterior leg, the length of the interior leg typically being the length of the exterior leg to the folded end of the bead.

The exterior leg is folded to form a bead having an interior angle of from about 15 degrees to about 25 degrees before being installed on the trailing edge of the door, and preferably, the exterior leg is folded to form a bead having an interior angle of about 20 degrees before being installed on the trailing edge of the door.

In one arrangement, the exterior leg is folded inwardly to form the bead, and in another arrangement, the exterior leg is folded outwardly to form the bead, and the exterior leg bends inwardly to add tension between the legs, thereby holding the door edge guard more firmly in place.

In a preferred form of the door edge guard, the metal body is stainless steel, the insulating cover is polyvinylchloride, and the colored material is polyvinylfluoride or a base coat paint covered with a clear coat or the cover is urethane and the colored material is a base coat paint covered with a clear coat. In one arrangement, the insulating material covering the internal portion of the metal body is matte black, but with a color finish applied over it, and the insulating material covering the exterior portion of the metal body is a stainless steel finish. In another arrangement, the insulating material covering the internal portion and the external portion of the interior leg of the metal body is matte black with a color finish and the insulating material covering the exterior portion of the exterior leg of the metal body is a stainless steel finish. In yet another arrangement, a step insulated edge is formed on the exterior end of the interior leg.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a side view of an automobile including the preferred embodiment of a door edge guard according to the invention;

FIG. 2 is a sectional view of the door edge guard of the invention, as seen along lines 2-2 in FIG. 1;

FIG. 3 is an alternative embodiment of the door edge guard of FIG. 2;

FIG. 4 is another alternative embodiment of the door edge guard of FIG. 2;

FIG. 5 is a third alternative embodiment of the door edge guard of FIG. 2; and

FIG. 6 is a fourth alternative embodiment of the door edge guard of FIG. 2.

### DETAILED DESCRIPTION OF THE INVENTION

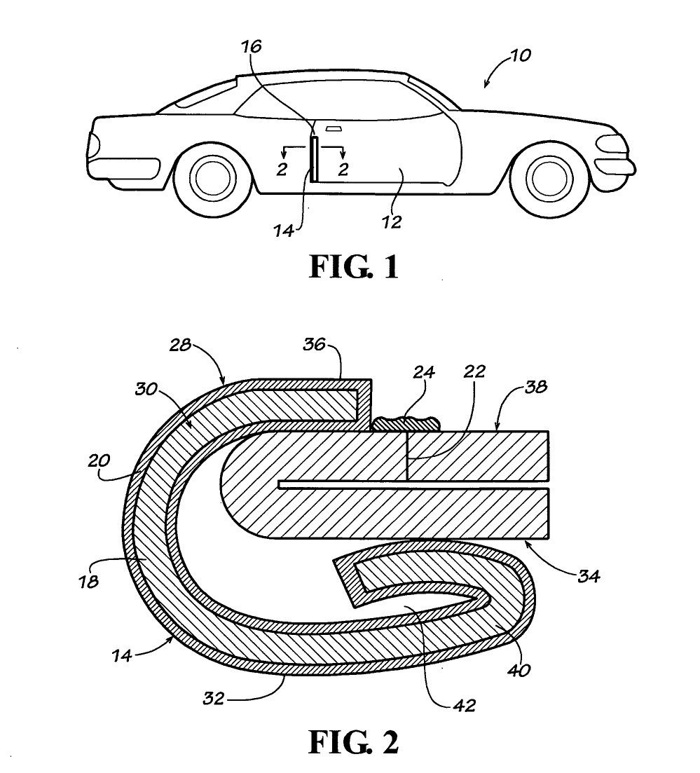

Referring now to the drawing, and in particular to FIG. 1, a typical automobile is referred to by reference numeral 10, and it has a standard door 12. A door edge guard 14 is mounted on the trailing edge 16 of the door 12. Referring now to FIG. 2, door edge guard 14 is mounted on the trailing edge 16 of the door 12. Door edge guard 14 has a metal body 18, preferably stainless steel, but it may also be aluminum or some other metal. The metal of the automobile door 12 is generally carbon steel. Since the door 12 and the body 18 of the door edge guard 14 are made of different metals, it is preferable that the two metals be insulated. The metal body 18 of door edge guard 14 is, therefore, completely surrounded by a plastic insulating cover 20. Plastic insulating cover 20 is preferably made of polyvinylchloride (PVC) or urethane.

Door edge guard 14 for protecting trailing edge 16 of door 12 having a seam 22 covered by sealant 24 on the interior of the door, includes metal body 18 having an internal portion 26 facing the trailing edge and an exterior portion 28 facing away from the trailing edge of the door. Sealant 24 is factory installed to cover seam 22. Typically, sealant 24 is trimmed away before installing a door edge guard, adding an additional time consuming step to installing a door edge guard. A curved base 30 is adapted to fit over the trailing edge. An exterior leg 32 extends from base 30 to fit against an exterior side 34 of the door, and an interior leg 36 extends from base 30 to fit against that part of an interior side 38 of the door extending from the base to near sealant 24, and insulating cover 20 is co-extruded or laminated onto and completely surrounding metal body 18 to prevent contact between the metal body and metal in the door. The end of exterior leg 32 of the metal body on the exterior side 34 of the door is folded to form a bead 40. In this arrangement, exterior leg 32 is folded inwardly to form the bead. Interior leg 36 is straight, that is to say not folded to form a bead. The interior leg is also shorter than the exterior leg, the length of the interior leg typically being the length of the exterior leg to the folded end of the bead. The curved base has a radius on the back side that hooks the interior leg inward, thereby gripping the trailing edge of the door.

The exterior leg is folded to form a bead having an interior angle 42 of from about 15 degrees to about 25 degrees before being installed on the trailing edge of the door, thereby creating spring tension against the door, and preferably, the exterior leg is folded to form a bead having an interior angle of about 20 degrees before being installed on the trailing edge of the door, thereby creating spring tension against the door.

In a preferred form of the door edge guard, metal body 18 is stainless steel, insulating cover 20 is polyvinylchloride, and the colored material is polyvinylfluoride or a base coat paint covered with a clear coat or the cover is urethane and the colored material is a base coat paint covered with a clear coat.

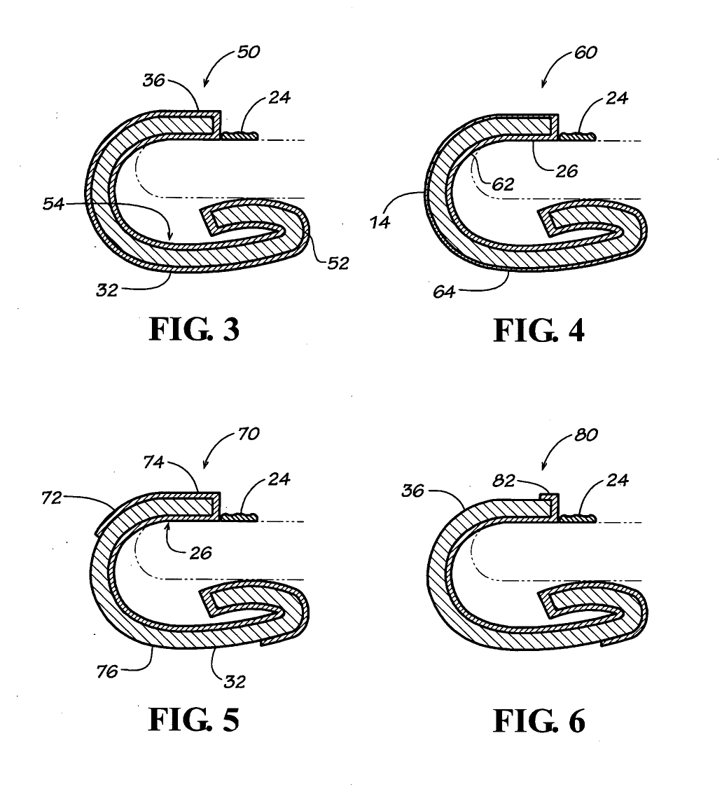

Referring now to FIG. 3, an alternative embodiment of a door edge guard according to the present invention is referred to generally by reference numeral 50, in which similar elements are numbered the same as in FIG. 1. Exterior leg 32 is folded outwardly to form a bead 52, and exterior leg 32 bends inwardly 54 to add tension between the legs, thereby holding the door edge guard more firmly in place.

Referring now to FIG. 4, an alternative embodiment of a door edge guard according to the present invention is referred to generally by reference numeral 60, wherein similar elements are referred to by the same reference numerals as in FIG. 1. The insulating material 62 covering the internal portion 26 of the metal body is matte black, but with a color finish applied over it, and the insulating material 64 covering the exterior portion 28 of the metal body is a stainless steel finish. Referring also to FIG. 5, yet another alternative embodiment of a door edge guard according to the present invention is referred to generally by reference numeral 70, again wherein similar elements are referred to by the same reference numerals as in FIG. 1. The insulating material 72 covering the internal portion 26 and the external portion 74 of interior leg of the metal body is matte black with a color finish and the insulating material covering the exterior portion 76 of exterior leg 32 of the metal body is a stainless steel finish. Referring now to FIG. 6, still another embodiment of a door edge guard according to the present invention is referred to generally by reference numeral 80, a step insulated edge 82 is formed on the exterior end of interior leg 36, therefore more closely matching sealant 24 in height and provided extra insulation at a critical point of contact. In each case, the curved base has a radius on the back side that hooks the interior leg inward, thereby gripping the trailing edge of the door.

It can now be seen that a door edge guard according to the present invention can be installed without the need for trimming the sealant, eliminating a step and not disturbing the function of the sealant.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A door edge guard for protecting a trailing edge of a door for an automobile, the door having an interior side facing the interior of the automobile and an exterior side facing away from the automobile, the door having a seam covered by a factory installed sealant on the interior side of the door, comprising:
a metal body having an internal portion facing the trailing edge of the door and an exterior portion facing away from the trailing edge of the door,
a curved base adapted to fit over the trailing edge of the door;
an exterior leg extending from the base to fit against the exterior of the door wherein the end of the leg of the metal body on the exterior of the door is folded to form a bead;
an interior leg to fit against that part of the interior of the door extending from the curved base to near the sealant but not is not long enough to go over the sealant, whereby the sealant does not need to be trimmed and wherein the exterior leg is longer than the interior leg;
an insulating cover coextruded or laminated onto the metal body to prevent contact between the metal body and metal in the door, wherein the curved base has a radius on the back side that hooks the interior leg inward, thereby gripping the trailing edge of the door and the door edge guard can be installed without removing the factory installed sealant.

2. The door edge guard of claim 1, wherein the interior leg is not folded to form a bead.

3. The door edge guard of claim 2, wherein the exterior leg is folded to form the bead having an interior angle of from about 15 degrees to about 25 degrees before being installed on the trailing edge of the door.

4. The door edge guard of claim 3, wherein the metal body is stainless steel, the insulating cover is polyvinylchloride, and wherein the door edge guard further comprises a colored material, which covers the insulating cover and is polyvinyl fluoride or a base coat paint covered with a clear coat or the cover is urethane and the colored material is a base coat paint covered with a clear coat.

5. The door edge guard of claim 2, wherein the exterior leg is folded to form the bead having an interior angle of about 20 degrees before being installed on the trailing edge of the door.

6. The door edge guard of claim 5, wherein the metal body is stainless steel, the insulating cover is polyvinylchloride, and wherein the door edge guard further comprises a colored material, which covers the insulating material and is polyvinyl fluoride or a base coat paint covered with a clear coat or the cover is urethane and the colored material is a base coat paint covered with a clear coat.

7. The door edge guard of claim 1 wherein the exterior leg is folded inwardly to form the bead.

8. The door edge guard of claim 7, wherein the interior leg is not folded to form a bead.

9. The door edge guard of claim 8, wherein the exterior leg is folded to form the bead having an interior angle of from about 15 degrees to about 25 degrees before being installed on the trailing edge of the door.

10. The door edge guard of claim 9, wherein the metal body is stainless steel, the insulating cover is polyvinylchloride, and wherein the door edge guard further comprises a colored material, which covers the insulating material and is polyvinyl fluoride or a base coat paint covered with a clear coat or the cover is urethane and the colored material is a base coat paint covered with a clear coat.

11. The door edge guard of claim 8, wherein the exterior leg is folded to form the bead having an interior angle of about 20 degrees before being installed on the trailing edge of the door.

12. The door edge guard of claim 11, wherein the metal body is stainless steel, the insulating cover is polyvinylchloride, and wherein the door edge guard further comprises a colored material, which covers the insulating material and is polyvinyl fluoride or a base coat paint covered with a clear coat or the cover is urethane and the colored material is a base coat paint covered with a clear coat.

13. The door edge guard of claim 1 wherein the exterior leg is folded outwardly to form the bead, and the exterior leg bends inwardly to add tension between the legs, thereby holding the door edge guard more firmly in place on the door edge.

14. The door edge guard of claim 13, wherein the interior leg is not folded to form a bead.

15. The door edge guard of claim 14, wherein the exterior leg is folded to form the bead having an interior angle of from about 15 degrees to about 25 degrees before being installed on the trailing edge of the door.

16. The door edge guard of claim 15, wherein the metal body is stainless steel, the insulating cover is polyvinylchloride, and wherein the door edge guard further comprises a colored material, which covers the insulating material and is polyvinyl fluoride or a base coat paint covered with a clear coat or the cover is urethane and the colored material is a base coat paint covered with a clear coat.

17. The door edge guard of claim 16, wherein the coextruded or laminated insulating cover completely surrounds the metal body.

18. The door edge guard of claim 14, wherein the exterior leg is folded to form the bead having an interior angle of about 20 degrees before being installed on the trailing edge of the door.

19. The door edge guard of claim 18, wherein the metal body is stainless steel, the insulating cover is polyvinylchloride, and wherein the door edge guard further comprises a colored material, which covers the insulating material and is polyvinyl fluoride or a base coat paint covered with a clear coat or the cover is urethane and the colored material is a base coat paint covered with a clear coat.

20. The door edge guard of claim 19, wherein the coextruded or laminated insulating cover completely surrounds the metal body.

21. The door edge guard of claim 14 wherein the insulating material covering the internal portion of the metal body is matte black, wherein the door edge guard further comprises a colored material to provide a color finish applied over the matte black of the insulating cover and the exterior portion of the metal body has a stainless steel finish.

22. The door edge guard of claim 14 wherein the insulating material covering the internal portion and the external portion of the interior leg of the metal body is matte black, wherein the door edge guard further comprises a colored material to provide a color finish applied over the matte black and the insulating material covering the exterior portion of the exterior leg of the metal body is a stainless steel finish.

23. The door edge guard of claim 14 wherein a step insulated edge is formed on the exterior end of the interior leg.

24. The door edge guard of claim 1 wherein the interior leg is not folded to form a bead and a step insulated edge is formed on the exterior end of the interior leg.
